(19) United States
(12) Patent Application Publication
(10) Pub. No.: US 2015/0092305 A1
(43) Pub. Date: Apr. 2, 2015

(54) Virtual Circuit Breaker

(71) Applicant: Astronics Advanced Electronic Systems Corp., Kirkland, WA (US)

(72) Inventor: Massoud Vaziri, Redmond, WA (US)

(73) Assignee: Astronics Advanced Electronic Systems Corp., Kirkland, WA (US)

(21) Appl. No.: 14/044,303

(22) Filed: Oct. 2, 2013

(51) Int. Cl. H02H 3/10; H02H 3/16

(52) U.S. Cl. CPC H02H 3/10; H02H 3/16
USPC 361/42; 361/63

(57) ABSTRACT

A virtual circuit breaker having an electrical relay and a control circuit, the control circuit including a load and wire protection (“OC”) detection unit, a microprocessor and a driver. The OC detection unit is configured to monitor a power flow and the electrical relay is effective to control it. The driver is effective to cause the relay to stop the power flow upon receipt of a deactivation command. The OC detection unit is effective to cause the driver to receive a deactivation command if the OC detection unit senses that a short circuit condition or an overload condition exists. The microprocessor of the control unit is configured so as to be capable of, at least, receiving input from the OC detection unit and sending output to the driver.

### FIELD OF THE DISCLOSURE

The subject matter of the present disclosure generally relates to circuit control devices, and more particularly relates to virtual circuit breakers utilizing microprocessors.

### BACKGROUND OF THE DISCLOSURE

Control devices for circuits are important in many electrical applications. For instance, various circuit breaker designs that are useful in numerous applications have been previously developed and disclosed.

In current aerospace power distribution systems, electrical loads are fed through a thermal circuit breaker and a power relay connected in-series, in order to provide load and wire protection (over-current or “OC”) and load On/Off control (switching). Alternatively, a Solid State Power Controller (SSPC) may be used to perform these same functions.

The thermal circuit breaker/power relay solution has a long service history, but this combination can be bulky and labor intensive for installation and trouble shooting. The SSPC solution has also been successfully implemented and operated with favorable service history. However, SSPCs are not cost and/or volume effective for higher power loads, largely due to the fact such applications require a high number of metal-oxide-semiconductor field-effect transistors (MOSFETs).

By example, U.S. Pat. No. 6,470,224 to Drake et al. discloses an aircraft power system including a SSPC disposed within a secondary power distribution assembly. Another example is U.S. Patent Application Publication No. 2013/0100567 to Reynolds et al., which discloses a system for protecting electrical power distribution circuits. Yet another example is U.S. Patent Application Publication No. 2013/0050880 to Rozman et al., which discloses a solid state power controller system. The disclosures of Pat. No. 6,470,224 and Patent Application Publication Nos. 2013/0100567 and 2013/0050880 are incorporated by reference herein in their entirety.

The subject matter of the present disclosure is directed to overcoming, or at least reducing the effects of, one or more of the problems set forth above.

### BRIEF SUMMARY OF THE DISCLOSURE

Disclosed is a virtual circuit breaker (VCB) having an electrical relay and a control circuit. The electrical relay is effective to control the power flow of a power line. The control circuit has a load and wire protection (“OC”) detection unit, a microprocessor and a driver. When an overload or short circuit condition is detected, the driver receives a command that the relay should stop the flow of power in the power line and, in return, the relay is caused to shut off power flow in the line, thus preventing or mitigating potential damage and/or harm.

There exists many different embodiments of the disclosed system, including many that have additional functionality to that discussed above. For instance, a redundant power supply can allow the relay and control circuit to operate without another source of power. A ground fault interrupt (GFI) detection unit can sense, and begin the response to, a ground fault condition. The microprocessor of the control circuit can actively control the circuit's operation, and in some embodiments, receive and communicate information with other components outside the disclosed system.

The disclosed subject matter presents several advantages over previously available systems and methods.

One advantage of the disclosed subject matter is that it can be utilized with 1-phase Alternating Current (AC), 3-phase AC or 3-phase Direct Current (DC) power.

Another advantage is that utilization of the disclosed subject matter may decrease overall project costs, depending in part on the load rating of any particular implementation.

Yet another advantage of the disclosed subject matter is that it allows for the utilization of conventional, proven components such as off the shelf (OTS) power relays and control circuits. This may, in turn, result in schedule and project cost reductions.

Yet another advantage of the disclosed subject matter is that an over-current rating change only requires a software set-point change, given that the power relay should be compatible for the highest programmable VCB rating.

### BRIEF DESCRIPTION OF THE DRAWINGS

The foregoing summary, preferred embodiments, and other aspects of the subject matter of the present disclosure will be best understood with reference to a detailed description of specific embodiments, which follows, when read in conjunction with the accompanying drawings, in which:

FIG. 1 is a schematic diagram of an embodiment, having a power bus, relay, load and control circuit.

FIG. 2 is a schematic diagram of the embodiment of FIG. 1, having additional features such as a redundant board power supply and GFI detection function.

FIG. 3 is a schematic diagram of an embodiment having two relays, each connected to a dedicated driver.

Like reference numbers and designations in the various drawings indicate like elements. Arrows in the schematic drawings should be understood to represent logic pathways that are generally indicative of the flow direction of information or logic, and that such arrows do not necessarily represent traditional electrical pathways.

### DETAILED DESCRIPTION OF THE DISCLOSURE

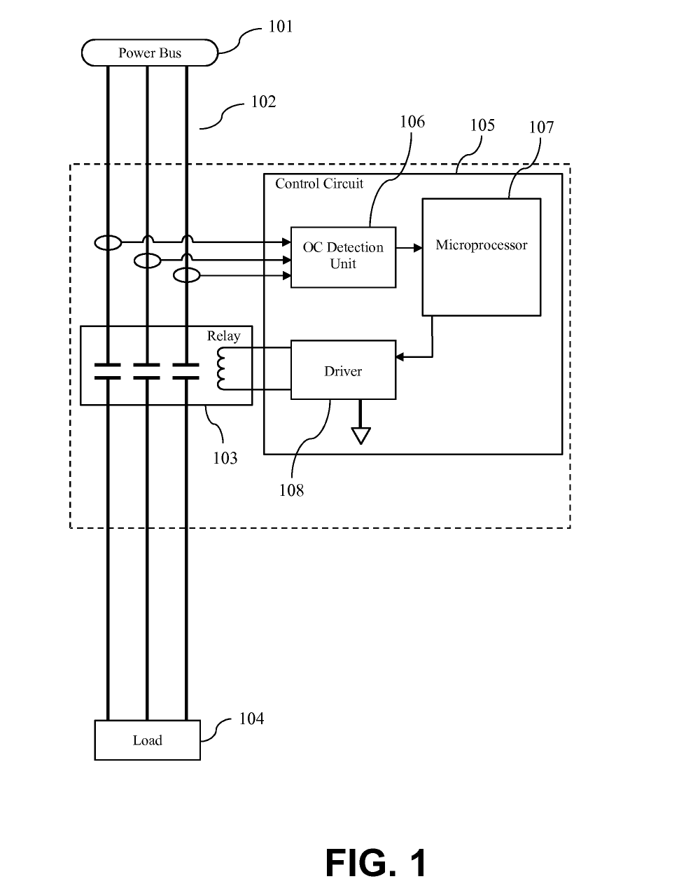

FIG. 1 is a schematic diagram of one embodiment VCB. A power bus 101, which may be a source of limited power, such as a generator on an aircraft, supplies an amount of power flow along power line 102, which is in this embodiment carrying 3-phase AC power. It should be understood that the disclosed subject matter can be utilized with 1-phase AC and 3-phase AC power, as well as other power configurations, including without limitation 28 VDC and 270 VDC. Electrical relay 103 is effective to control this power flow. For example, relay 103 can allow power to flow from power bus 101 to load 104 or, inversely, prevent such flow. Various electrical relays are suitable for use with the disclosed subject matter, including by way of example commercially available OTS units. Control circuit 105 includes OC detection unit 106, microprocessor 107 and driver 108. Upon receipt of a deactivation command, driver 108 is effective to cause relay 103 to stop the flow of power in power line 102. OC detection unit 106 is configured to monitor the power flow in power line 102 with, for example, a current sensor(s). OC detection unit 106 is capable of detecting whether a short circuit or overload condition exists. If one of these conditions is sensed, OC detection unit 106 causes driver 108 to receive a deactivation command, which, in turn, would cause the power flow in power line 102 to be shut off, thereby preventing or limiting the damage or harm that might otherwise be caused by an overload or short circuit condition. Microprocessor 107 is configured to, at a minimum, be capable of receiving input from OC detection unit 106 and sending output to driver 108. It is understood that microprocessor 107 may perform any number of additional functions, and may be programmable to operate and control the control circuit 105 in a variety of fashions.

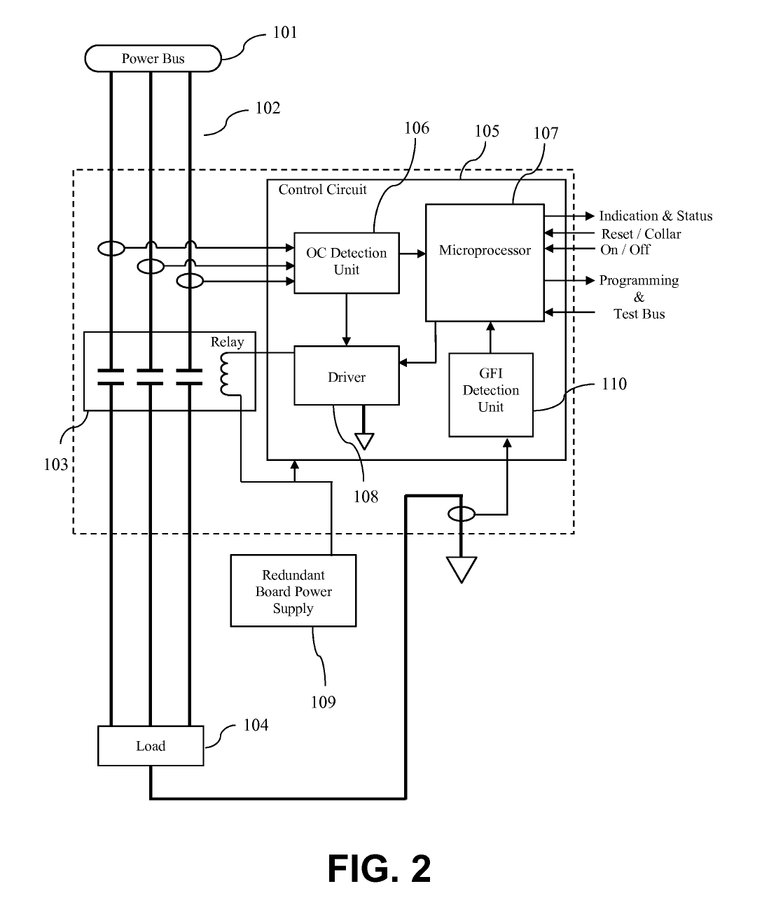

FIG. 2 is a schematic diagram of the embodiment of FIG. 1 having additional features and functionality. Redundant Board Power Supply 109 is connected to control circuit 105 and relay 103 and is effective to allow control circuit 105 and relay 103 to operate even when redundant board power supply is the only power source for these units. Such a redundant power supply increases overall system integrity and can help guard against unexpected power loss from other sources. This can be particularly important in applications, such as aircraft, where it is critical that system functionality be maintained even in the event of a loss of primary power.

In the embodiment of FIG. 2, microprocessor 107 is capable of sending and receiving various information outside of the control circuit. Such functionality may be useful in applications where control of the embodiment system by an outside entity, for instance a flight officer of an aircraft, is advantageous or required. In the embodiment, indication and status information is sent outside of the embodiment system. This information, by way of example, may be recorded, viewed, analyzed or otherwise manipulated. For example, a visual control panel in the cockpit of an aircraft could indicate to a flight officer that the embodiment system is operating effectively. It is understood that there are many human interface schemes, for example, flight deck multi-function displays (MFDs), capable of being utilized with the disclosed subject matter and which will be apparent to those of skill in the art to which the present disclosure pertains.

In the embodiment of FIG. 2, microprocessor 107 is effective to receive “reset,” “collar,” “on,” and “off” commands from outside of the embodiment system. This allows the embodiment system, and thus the power flow in power line 102, to be controlled remotely, either automatically or by a human operator. For instance, upon receipt of an “off” command by the microprocessor, the microprocessor may cause driver 108 to receive a deactivation command and thereby cause relay 103 to shut off power flow in power line 102.

In the embodiment of FIG. 2, microprocessor 107 is effective to communicate with a programming and test bus. This allows for the embodiment virtual circuit breaker to be tested to ensure correct operation, and in certain embodiments, for the circuit to be programmed with various settings and/or for various tasks. For example, the threshold for determining that an overload condition existed in the circuit could be raised, to for example, account for an unusual or increased amount of noise in power line 102. It should be understood that microprocessor 107 may receive input from various input devices, such as control panels, keyboards, etc.

The embodiment depicted by FIG. 2 includes GFI detection unit 110. In the particular embodiment, the GFI detection unit 110 is integrated with control circuit 105, but could optionally be not integrated. GFI detection unit 110 is effective to, when it senses that a ground fault condition has occurred, communicate to the microprocessor that such a condition has occurred. This allows the embodiment system to detect and react to ground fault conditions. In an embodiment, an arc fault detection and protection algorithm can be programmed into the microprocessor. In another embodiment, GFI protection can be added by including an additional current sensor (i.e., current transformer or hall effect sensor).

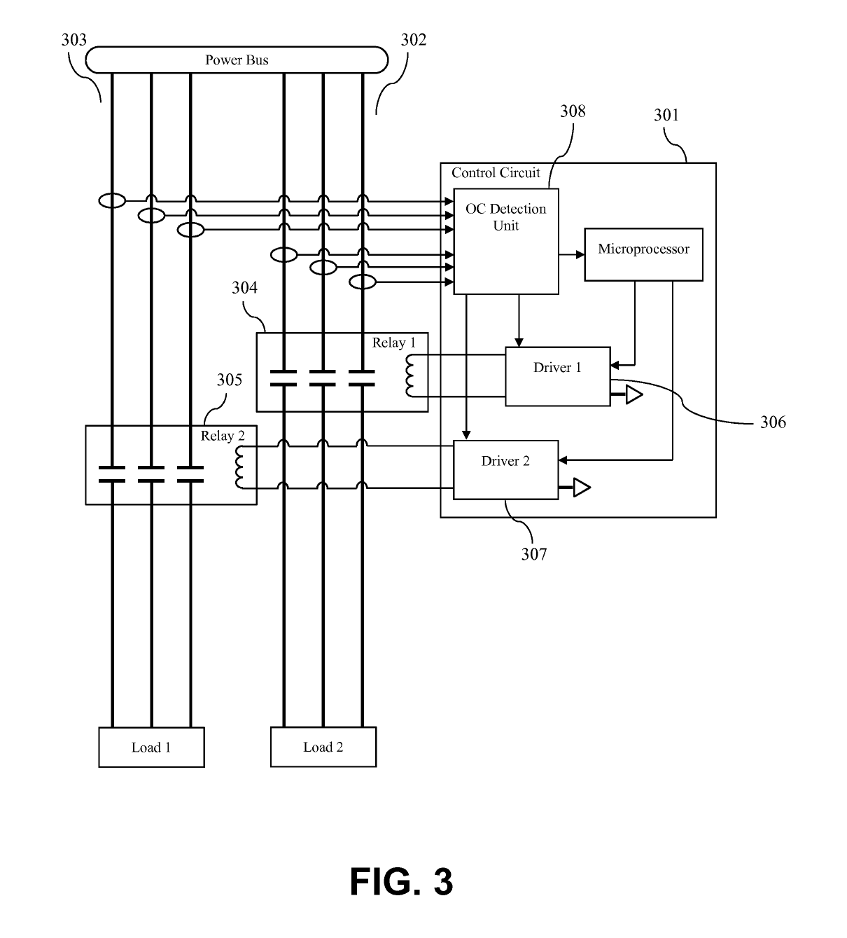

FIG. 3 is a schematic depiction of an embodiment in which a single control circuit 301 operates to control the power flow in both first power line 302 and second power line 303. In the embodiment, first relay 304 is effective to control the flow of power in first power line 302. Similarly, second relay 305 is effective to control the flow of power in second power line 303. First driver 306 is effective to cause first relay 304 to stop the flow of power in first power line 302 upon receipt by first driver 306 of a deactivation command. Similarly, second driver 307 is effective to cause second relay 305 to stop the flow of power in second power line 303 upon receipt by second driver 307 of a deactivation command. OC detection unit 308 monitors both first power line 302 and second power line 303 and is effective to cause first driver 306 or second driver 307 to receive a deactivation command if a current overflow or short circuit condition is detected in first power line 302 or second power line 303, respectively. As illustrated by the embodiment depicted by FIG. 3, components utilized in practicing the disclosed subject matter need not have one-to-one relationships with one another or exist only in single units.

It should be understood that various components of the disclosed subject matter may communicate with one another in various manners. For instance, components may communicate with one another via a wire or, alternatively, wirelessly and by electrical signals or via digital information. It is noted that PWB may be utilized in the construction of many embodiments.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. A virtual circuit breaker, comprising:
an electrical relay effective to control an amount of power flow;
a control circuit, having a Load and Wire Protection (“OC”) detection unit, a microprocessor and a driver;
said driver effective to cause said relay to stop said power flow upon receipt by the driver of a deactivation command;
said OC detection unit configured to monitor said power flow;
said OC detection unit effective to cause said driver to receive a deactivation command if said OC detection unit senses that a short circuit condition or an overload condition exists; and
said microprocessor configured to be capable of receiving input from said OC detection unit and sending output to said driver.

2. The virtual circuit breaker of claim 1 wherein said power flow is selected from the group consisting of 1-phase alternating current (AC), 3-phase AC and direct current (DC).

3. The virtual circuit breaker of claim 2 wherein said power flow is 1-phase AC and said virtual circuit breaker is located on an aircraft.

4. The virtual circuit breaker of claim 1 wherein said microprocessor is effective to send to outside said control circuit an amount of indication and status information.

5. The virtual circuit breaker of claim 4 wherein said microprocessor is effective to send said information to an aircraft cockpit.

6. The virtual circuit breaker of claim 1 wherein said microprocessor is effective to receive at least one command.

7. The virtual circuit breaker of claim 6 wherein said virtual circuit breaker is located on an aircraft and said microprocessor receives at least one of “reset,” “collar,” “on” or “off” commands from a control panel in said aircraft.

8. The virtual circuit breaker of claim 7 wherein said microprocessor is effective to cause said driver to receive a deactivation command upon receipt by the microprocessor of an “off” command.

9. The virtual circuit breaker of claim 1 wherein said microprocessor is effective to communicate with a programming and test bus.

10. The virtual circuit breaker of claim 1, further comprising a redundant source of power effective to allow said control circuit and said relay to operate while only receiving power from said redundant source of power.

11. The virtual circuit breaker of claim 1 further comprising a ground fault interruption (GFI) detection unit.

12. The virtual circuit breaker of claim 11 wherein said GFI detection unit is effective to, when the GFI detection unit senses that a ground fault condition has occurred, communicate to said microprocessor that a ground fault condition has occurred.

13. The virtual circuit breaker of claim 12 wherein said GFI detection unit is integrated with said control circuit.

14. An electrical system for an aircraft, comprising
a source of limited power;
a load, drawing an amount of power flow from said source of limited power;
an electrical relay effective to control said amount of power flow;
a control circuit, having a Load and Wire Protection (“OC”) detection unit, a microprocessor and a driver;
said driver effective to cause said relay to stop said power flow upon receipt by the driver of a deactivation command;
said OC detection unit configured to monitor said power flow;
said OC detection unit effective to cause said driver to receive a deactivation command if said OC detection unit senses that a short circuit condition or an overload condition exists; and
said microprocessor configured to be capable of receiving input from said OC detection unit and sending output to said driver.

15. The electrical system of claim 14, wherein said source of limited power is an aircraft engine.

16. The electrical system of claim 15, wherein said load is the actuator mechanism of an aircraft control surface.

17. A method of protecting an electronic circuit, comprising the steps of:
providing a power flow;
providing an electrical relay effective to control said amount of power flow;
providing a control circuit, having a Load and Wire Protection (“OC”) detection unit, a microprocessor and a driver, wherein said driver is effective to cause said relay to stop said power flow upon receipt by the driver of a deactivation command, and wherein said microprocessor is configured to be capable of receiving input from said OC detection unit and sending output to said driver;
monitoring said power flow utilizing said OC detection unit; and
causing said driver to receive a deactivation command when one of a short circuit condition or an overload condition is sensed.

18. The method of claim 17 wherein said power flow is 1-phase AC and said virtual circuit breaker is located on an aircraft.

19. The method of claim 17 wherein said microprocessor is effective to receive commands from and send information to outside said control circuit.

20. The method of claim 17 wherein said microprocessor is effective to cause said driver to receive a deactivation command upon receipt by the microprocessor of an “off” command.
